(19) United States
(12) Patent Application Publication
(10) Pub. No.: US 2006/0273237 A1
(43) Pub. Date: Dec. 7, 2006

(54) Video Presentation of Photomultiplier Anode Signal

(75) Inventor: Robert C. Thompson, Lancaster, PA (US)

Correspondence Address: DANN, DORFMAN, HERRELL & SKILLMAN, 1601 MARKET STREET, SUITE 2400, PHILADELPHIA, PA, 19103-2307, US

(73) Assignee: BURLE TECHNOLOGIES INC., Wilmington, DE (US)

(21) Appl. No.: 11/160,020

(22) Filed: Jun. 6, 2005

(51) Int. Cl. H01J 40/14

(52) U.S. Cl. 250/207

(57) ABSTRACT

An apparatus and method for video imaging the spatial response of radiation-responsive devices, such as photomultiplier tubes. The apparatus probes the device under-test with an array of radiation emitting elements, such as light-emitting diodes, programmed with a scanning sequence such that the device under-test output response, e.g., the anode current of a photomultiplier tube, may serve as a video signal to a video display device such as a television or monitor. A video image so produced provides a map of the spatial response of the radiation-responsive device which may indicate perturbances, flaws, and inhomogeneities in the spatial responsivity of the device.

### FIELD OF THE INVENTION

This invention concerns instrumentation to perform diagnostics on photomultiplier tubes and other optical detection devices. More particularly, the invention relates to an apparatus that creates a video image that is representative of the variations in localized responsivity and gain of the photosensitive elements and associated electrodes of a photomultiplier tube. The invention can also be used to assess spatial variations in responsivity of other types of devices such as image intensifiers, semiconductor detectors, and solar cells.

### BACKGROUND OF THE INVENTION

Photomultiplier tubes are vacuum tube optical detection devices that generate a real-time electrical signal in response to incident radiation. Ideally, the magnitude of the electrical response is proportional to the intensity of the incident radiation. Photomultiplier tubes provide high gain, fast response, and good sensitivity due to their inherent amplification and low-noise characteristics. As with all optical detectors, photomultipliers present an active, photosensitive area which is illuminated by some electromagnetic (e.g., optical) radiation of interest for detection and measurement. In the case of a photomultiplier tube, the active area is essentially the surface of the photocathode that is exposed to the incident radiation to be measured, or relatedly, the area of the transparent faceplate that admits radiation into the enclosure and in which such radiation is made incident upon one or more photocathodes. In certain types of photomultiplier tubes, the active, i.e., radiation-sensitive, area is on the order of tens or hundreds of square centimeters. The uniformity of photomultiplier tube response to light over the photosensitive areas of the photomultiplier tube is an important consideration.

Referring now to FIG. 1A, a known photomultiplier tube is constructed in the form of a tube 102 sealed at both ends to form an evacuated enclosure 104. The tube may be of circular or rectangular cross-sectional shape. At one end of the tube is a stem plate 106 through which electrical connections 108 are made to several electrodes including the photocathode 110, several dynodes 112, 114 and 116, and an anode 118. At the end opposite the stem plate, a faceplate 120 of clear glass is sealed to the tube. The glass faceplate is essentially a window to admit radiation into the enclosure. In one common version of photomultiplier tubes, the side of the glass faceplate 120 on the inside of the enclosure is coated with a material 110 with good photoemissive characteristics. This photoemissive coating material absorbs the photons of the incident radiation 122 admitted through the faceplate 120, and emits one or several electrons 124. In this context, the electrons so emitted in response to the absorption of a photon are called “secondary electrons.” The photoemissive coating thus functions as a photocathode 110. The secondary electrons 124 are accelerated toward a metal electrode 112—termed a dynode—that is in close proximity to the photocathode 110 and that is voltage biased positively with respect to the photocathode, which is normally electrically grounded. The electrons 124 emitted from the photocathode 110 stimulate the emission of further electrons 126, that are typically greater in number than the impacting electrons 124 that stimulated their emission. The electrons emitted from said dynode are accelerated toward a second dynode 114, in close proximity to the first dynode 112, and that is biased positive with respect to the first dynode mentioned above, and create another round of secondary electrons 128, greater in number than the secondary electrons emitted from the first mentioned dynode. This cascade of absorption and emission of secondary electrons, and the inherent amplification that accompanies it, continues according to the number of dynodes in the photomultiplier tube. The electron cascade terminates with the impact of secondary electrons 130 on an anode grid 118, creating an electric current that can be sensed by an ammeter 132 or other measuring device connected to the anode. The operation of a photomultiplier tube has two important aspects: (1) the generation of an electric current in the anode in response to the photocathode absorbing radiation, and (2) the amplification of the incident radiation in that a single photon of the incident radiation has induced a current of many electrons in the anode. The intrinsic gain is an important feature of photomultiplier tubes.

The quantum efficiency of a photomultiplier tube may be defined as the ratio of the average number of electrons emitted by the photocathode per photon absorbed in the photocathode at a given wavelength. Quantum efficiencies much in excess of 100% are typical with photomultiplier tubes, implying a substantial signal gain. A similar measure of performance is called the response or responsivity. Responsivity is defined as ratio of the anode current to incident optical power. To the extent that the responsivity varies with the energy—or equivalently, varies with the wavelength—of the incident photon absorbed by the photocathode, the responsivity is referred to as the spectral response.

The preceding description of photomultiplier tube structure and operation serves to illustrate features and effects that may contribute to variations in the response or anode current as a function of position of incident radiation on the photocathode or faceplate. FIG. 1A illustrates the localized response of a photomultiplier tube to several representative beams of radiation. A narrow beam of radiation 122 and the resultant cascade of secondary electrons that propagates from the photocathode to the anode induces a response in the form of anode current. Provided the intensity, spectral content, angle of incidence, and polarization of such and similar beams incident at different locations are identical, the anode current produced by each incident radiation beam should ideally be the same. However, in real photomultiplier tubes, this is often not the case. For example, another representative pencil of radiation, labeled 134, and identical in specification to the radiation pencil 122, except for the location on the faceplate which it is incident, may produce a different value of anode current.

A non-uniform response may be the result of some combination of flaws in the photomultiplier tube housing, the photocathode, the dynodes, the anode, or in their assembly. Such flaws may include inhomogeneities in the photocathode coating, intrinsic variations in gain resulting from the arrangement of the electrodes or cage optics, and the perturbing effects of external magnetic fields on electron optics internal to the photomultiplier tube. Also, there are various and practically unavoidable edge effects around the periphery of the photocathode that obscure the transmission of light to the photocathode. Thus, an effective and simple technology to evaluate the responsivity of photomultiplier tubes would be useful as a means of quality control in the manufacture of photomultiplier tubes, or to provide data that image processing algorithms can use to correct or compensate for spatial variations in responsivity.

Although the above description is specific to one type of photomultiplier tube, it is also applicable to other types of photomultiplier tubes. Those include photomultiplier tubes that include a separate photocathode electrode in the tube enclosure, several anodes, more complicated types of dynodes, electrode cages, and microchannel plates. Nevertheless, the basic issue of localized response uniformity, or lack thereof, over a photosensitive area, remains regardless of the details of the photomultiplier tube structure. Further, when a number of photomultiplier tubes are assembled into an array for imaging applications, such response uniformity issues of the individual photomultiplier tubes are important, if not critical.

The present invention can be regarded as a means to simultaneously integrate the several operations that are needed to provide a measure of photomultiplier areal response. The basis of this method can be understood by describing a series of manual operations that might be used to form an image or map of photomultiplier tube response. For example, if a beam of light is focused such that its diameter is considerably less than the active area of the photomultiplier, the light beam can be scanned over the surface of the photocathode or faceplate to probe the localized responsivity of the photomultiplier tube. Alternatively, the beam position can be held constant and the tube can be translated or rotated on a mechanical stage in a prescribed fashion. Ideally, except in cases where the beam was near the periphery of the photocathode and might partly overlap with the rim or collar that holds the faceplate or photocathode in place, the electrical signal generated by the incident beam should be constant and independent of the position of the beam. Instead, an actual photomultiplier tube may exhibit a variation of response as the beam is moved over the surface of the photocathode area. In the most drastic case, but which is not uncommon, the beam illuminates a “dead spot” of the photocathode that results in negligible anode current, i.e., near-zero responsivity.

Based on such probing of the photomultiplier tube response, the output of the photomultiplier tube can be recorded as a function of the position co-ordinates x and y of the probing light beam. For example, FIG. 1B shows an end-view of the photomultiplier tube of FIG. 1A upon which coordinate axes 134 and 136 and a rectangular grid 138 are superimposed to specify the co-ordinates of the position of the probing beam of radiation. On such axes or grids, the response data, i.e., the anode current, or else the responsivity or quantum efficiency calculated from the anode current and probe beam power, can be indicated for each position of the probing beam. The response could be represented as a gray scale image or a contour map providing both a visual impression and quantification of the response uniformity of the photomultiplier tube. Thus, in this manner a focused or collimated beam of light scanned over the surface of the photocathode can serve as a probe to assess the spatial response uniformity of a photomultiplier tube, and to detect defects and inhomogeneities. In practice, such a measurement would be tedious as the photomultiplier or light source would need to be mounted on an x-y stage, and the angle and position of the photodetector with respect to the light source would need to be carefully controlled so that the variation in response could be attributed solely to the photomultiplier tube rather than inconsistencies in the measurement technique. Uncertainties in the reproducibility of measurements associated with this technique would be especially acute in situations where the effects of external magnetic fields on photomultiplier tube responsivity were being assessed.

### SUMMARY OF THE INVENTION

The present invention provides an apparatus and method for assessing the spatial uniformity of response of photomultiplier tubes. The apparatus may be constructed from relatively inexpensive and readily available electronics and optics components, and can be used with a commercial television video monitor for easy and quick testing and evaluation of various performance aspects of photomultiplier tubes. Specifically, the system generates a video image that indicates the response uniformity of photomultiplier tubes. The video image is essentially a map of the variation of photomultiplier output as a function of the position of incident radiation on the light-sensitive photocathode of the photomultiplier tube. Any such non-uniformity of photomultiplier tube areal response might be attributed to a combination of inhomogeneities, flaws or edge effects in the cathode photoemission, faceplate transmissivity, dynode collection, cage optics, anode collection, or to the perturbing effects of external magnetic and/or electric fields on internal electron optics. The invention will find similar applications for other light-sensitive or radiation-responsive devices such as photodetectors and solar cells where areal response uniformity is also of interest.

The invention preferably uses a scanned light-emitting diode (LED) array to probe the localized response of a photomultiplier tube. More particularly, an LED array comprised of, for example, a matrix of 15 columns by 15 rows of light-emitting diode elements, is optically coupled to a photomultiplier tube. For many purposes, adequate optical coupling can be achieved by simply juxtaposing the LED array and photomultiplier tube such that the emissive surface of the light-emitting diode array sits atop and faces into the faceplate of the photomultiplier tube, and in a manner such that the optical emission of each LED is mostly incident upon the photocathode. The LED elements of the array are individually addressed by electrically biasing the appropriate row and column lines of the array. The array is powered by a combination of synchronizing, timing, and counter circuits that generate a periodic sequence of electric pulses on the address lines of the array, such that a single LED element of the array is electrically biased to emit light, while at the same time the remaining elements are inactive and non-emissive. The anode current of the photomultiplier tube is used as the video input to a closed-circuit television video monitor. The timing sequence of the electric pulses used to power the LED array is such that the LED emission pattern replicates the raster scan of commercial television technology. The LED biasing sequence thus includes the proper synchronization and vertical and horizontal blanking intervals so that a stable video image can be formed from the anode output of the photomultiplier tube.

In the usual mode of operation, there is a close relation between the brightness at any point of the video image so formed according to the above description and the responsivity of the device for radiation incident on the corresponding position of the photocathode or faceplate of the photomultiplier tube. For instance, the brightness of the center of the video image corresponds to the responsivity of the photomultiplier tube for radiation incident at the center of the faceplate. Provided the optical output of the LED array is stable and the light output of each LED element of the array are equal, the video image produced on the television monitor provides a visual image of the areal response uniformity of the photomultiplier tube. For example, a dark spot in the center of the video image would indicate a “dead spot” in the photomultiplier tube response for radiation incident at the center of the faceplate. In general, imperfections in the photocathode may mean that photons striking a particular sub-area of the photocathode exhibit a diminished photoemission relative to surrounding areas of the photocathode. This would be clearly indicated in the video image. As a further example, asymmetries in the arrangement of dynodes relative to the photocathode may cause electrons emitted from some parts of the photocathode to be amplified with a different gain than other parts of the photocathode. Therefore, the localized response of the photomultiplier tube will not be uniform over the faceplate of the photomultiplier tube. This effect would also be indicated in the video image. As a final example, external magnetic fields may skew the electron cascade initiated by photons incident on the photocathode. Thus, the video image provides a real time measurement of the perturbing effects of magnetic fields.

### BRIEF DESCRIPTION OF THE DRAWING FIGURES

Further novel features and advantages of the present invention will become apparent from the following detailed description and the accompanying drawings in which:

FIG. 1A is a schematic diagram of a known photomultiplier tube;

FIG. 1B is a top plan view of the photomultiplier tube of FIG. 1A with co-ordinate axes and a grid superimposed thereon;

FIG. 2 is a schematic block diagram of a system for video presentation of a photomultiplier anode signal according to the present invention;

FIG. 3 is a schematic diagram of a section of the LED array shown in FIG. 2;

FIGS. 4A and 4B are schematic diagrams showing preferred arrangements for the column and row counters and drivers shown in FIG. 2;

FIG. 5 is a schematic diagram showing a preferred arrangement for the horizontal and vertical timing generators and the corresponding column and row counters shown in FIG. 2;

FIG. 6 is a photograph of a video monitor display produced by a device according to the present invention; and

FIG. 7 is a functional block diagram of an alternative system for video presentation of a photomultiplier anode signal according to the present invention.

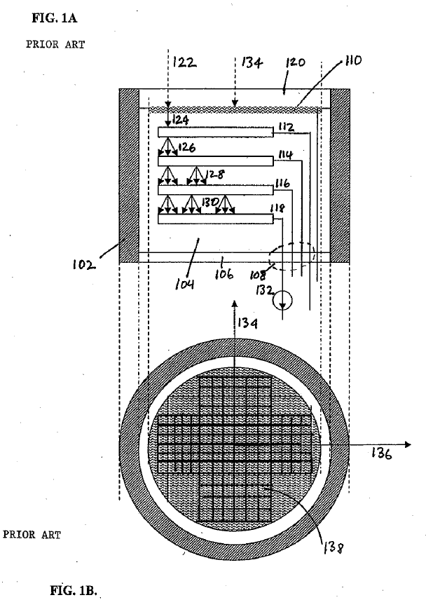

### DESCRIPTION OF THE PREFERRED EMBODIMENT

The present invention provides an apparatus and technique for producing a video image that is representative of the spatial-dependence of the response of a photomultiplier tube to incident radiation. The apparatus and process of the present invention utilize an array of light-emitting diodes (LED's) that are energized in a timing sequence that mimics a cathode ray tube raster scan used in commercial television technology. Specifically, a photomultiplier tube anode signal is modulated by the optical raster scanning of an LED array used to probe the photomultiplier tube. The modulated anode current functions as the camera component of a composite video signal input to a cathode ray tube television monitor. The video image so formed provides a representation of the spatial response uniformity of the photomultiplier tube.

In general, an array of light-emitting diodes is placed near the faceplate of a photomultiplier tube so that the radiative emission from the light emitting elements of the array excites the photocathode, stimulating the photoemission of secondary electrons, initiating an electron current cascade between the photomultiplier tube electrodes, and inducing an electric current in the photomultiplier tube anode. The radiative emission from each light-emitting diode of the array will produce a specific response in the anode current according to the position of the light-emitting diode element relative to the photomultiplier tube photocathode. This position-specific response is predicated on the presumed spatial inhomogeneities of response for the photomultiplier tube under test. The video image so formed will depend in part on the variation in anode current due to such photomultiplier tube response variations, and thus provides an indication of spatial uniformity, or lack thereof, of the photomultiplier tube response.

The LED array is closely optically coupled to a photomultiplier tube. This can be accomplished simply by mounting the photomultiplier tube upright and placing the light-emitting diode array over the faceplate in proximity thereto. During the test cycle, the photomultiplier tube is powered with the usual voltage bias levels used for normal operation as an optical detector or imaging device.

At any instant, one LED of the array is electrically biased to emit light, while the others are inactive and non-emissive. The scanning of the light-emitting diodes is carried out at standard closed-circuit television rates. The anode signal of the photomultiplier tube is input as the video signal to a television monitor and includes the standardized timing signals to drive a fully 2-to-1 interlaced, 525-line, 30-frame/second, video system. These timing sequences are preferably generated by a commercial integrated circuit typically used to drive a video camera.

A preferred arrangement of an imaging system according to this invention includes a circuit that is configured to address a 15 (columns)×15 (rows) array of 225 light emitting diodes. The individual column and row excitations are derived from a synchronization signal-generating integrated circuit providing 262 ½-lines per 60 Hz field for a resultant 525-line interlaced frame at the 30 Hz rate. Horizontal timing pulses are produced by a synchronization circuit. Those pulses, which are of the type used to initiate a horizontal sweep of the electron beam in a cathode ray tube, instead trigger a horizontal oscillator that clocks a horizontal ripple counter. The horizontal ripple counter generates a voltage pulse that is applied cyclically through the column lines of the LED array with the appropriate repetition rate. Similarly, the vertical timing pulses of the synchronization circuit are used to trigger a vertical oscillator that clocks a row ripple counter. The row ripple counter generates a voltage pulse that cycles through the row lines of the LED array with the appropriate repetition rate. Together, the cycling pulse on the row line in combination with the cycling pulse on the column line activate each LED in the array at the appropriate time so that LED emission simulates the raster scanning electron beam of a cathode ray tube in a pattern and rate compatible with a standard television video monitor.

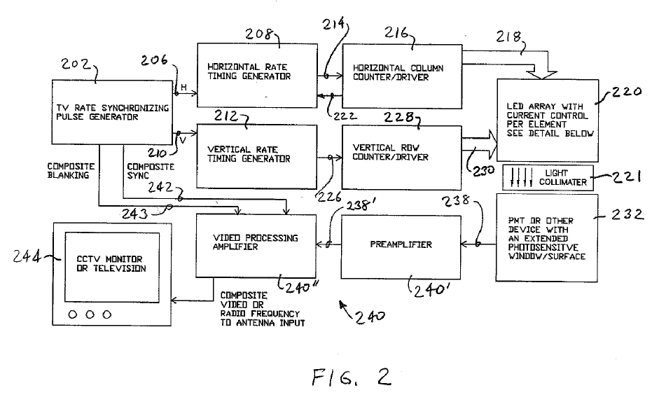

Referring now to FIG. 2, a synchronizing pulse generator 202 generates horizontal synchronization signal 206 that triggers a horizontal timing generator 208 and a vertical synchronization signal 210 that triggers a vertical timing generator 212. Horizontal timing generator 208 provides a clock signal 214 to the horizontal column counter 216. The horizontal column counter 216 includes drivers for generating separate pulse signals for 15 column lines 218 of an LED array 220 and a column count signal 222 to the clock stop input of the horizontal timing generator 208. Vertical timing generator 212 provides a clock signal 226 to vertical row counter 228. The vertical row counter 228 includes drivers which generate separate pulse signals for 15 row lines 230 of the LED array 220. The light output of LED array 220 is directed to the input window of a photomultiplier tube 232, or other device to be tested, preferably through a collimator 221. Photomultiplier tube 232 is the device under test and is biased for normal operation by a voltage divider network (not shown) which provides the various voltage bias levels for the photomultiplier tube electrodes. The anode output 238 of photomultiplier tube 232 is input to a video amplifier 240 which may consist of a preamplifier 240′ and a video processing amplifier 240″. In the video processing amplifier 240″, the preamplified anode signal 238′ is combined with a blanking signal 243 and a synchronizing signal 242 from synchronization circuit 202 to drive a video monitor 244 or television. The video signal driving the video monitor 244 may be either a composite video signal or a radio frequency signal.

The horizontal column counter 216 and the vertical row counter 228 each have 15 lines that are activated in succession to provide an appropriate voltage bias pulse to forward bias each of the LED's in the array 220 in a timed sequence. Upon receipt of the horizontal synchronization pulse 206 by the horizontal timing generator 208, the counter 216 ripples through 17 addresses and then halts, awaiting the next horizontal synchronization pulse. The first two addresses of horizontal column counter 216 are not used and their time duration constitutes the horizontal blanking interval of the composite video signal. This horizontal blanking interval corresponds to the horizontal retrace in standard video format. The other 15 addresses of the column counter output are input to the 15 column lines of the LED array 220. Similarly, the vertical row counter 228 is enabled when the vertical timing generator 212 receives the vertical synchronization pulse 210. The row counter generates 17 addresses. The first two addresses are not used and their interval corresponds to the vertical blanking period. The other 15 addresses are applied to the row lines of the LED array 220. This timing scheme generates a displayed frame of pixels (picture elements) that is 15 columns wide and 15 rows high.

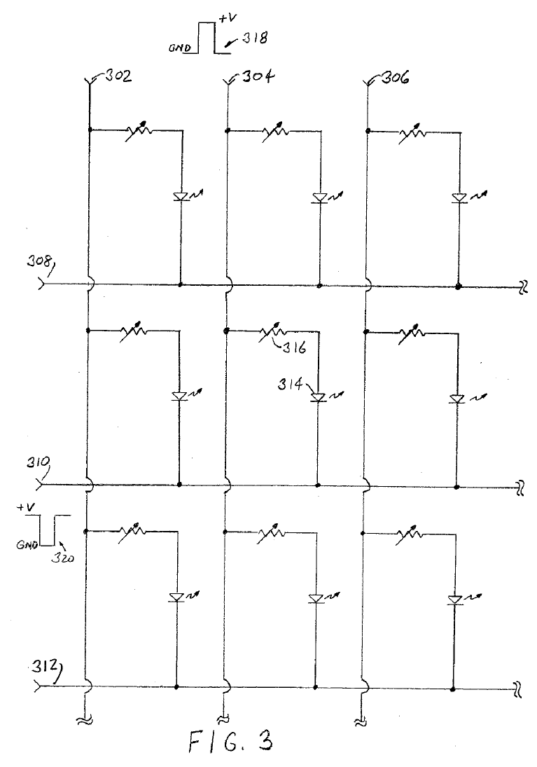

FIG. 3 is a more detailed view of a subsection of the LED array. Column lines 302, 304, and 306 cross row lines 308, 310, and 312. The intersection of each column and row line is bridged with an LED in series with a potentiometer (variable resistor) as shown. For instance, column line 304 is connected to row line 310 by LED 314 in series with potentiometer 316. The cathodes of the LED's are connected to the row lines, and the anodes of the LED's are connected through the potentiometer to the column lines. For most of the time, all of the column lines are held at ground (zero) potential. Similarly, all of the row lines are held at a high potential (e.g., +5 volts with respect to ground). Under these conditions, the LED's are reverse-biased, and conduct negligible current and emit no light. An LED is activated by imposing a high voltage (e.g., +5 volts with respect to ground) on its column line, and simultaneously biasing its row line at ground potential. In this manner, LED 314 is forward biased by a positive voltage pulse 318 on column line 304 and a negative voltage pulse 320 on row line 310 while all of the other LED's remain reverse-biased. When a particular column line is excited to a high voltage, and a particular row line is made common to ground, the LED element that is common to both said column line and said row line is forward-biased to conduct current and emit light. Thus, each LED element is individually addressed. The potentiometer 316 in series with each LED element can be operated to adjust the current in order to equalize the light emission from each LED element. The pulse sequencing of the voltage levels of the column lines is provided by column counter 216. The pulse sequencing of the voltage levels of the row lines is provided by row counter 228. The synchronization of the column counter and row counter needed to mimic a video raster scan is provided by the synchronizing pulse generator 202, the horizontal timing generator 208, and the vertical timing generator 212.

The LED array preferably utilizes LED's with nominally monochromatic emission spectra. On the other hand, LED's having other emission wavelengths can also be used in the array, thus providing information on spectral characteristics of the response. In this manner, so-called white light-emitting diodes that use phosphors to produce a broad spectrum output can be used in the LED array. The measurements can be made using various spectral filters interspersed between the photomultiplier tube and LED array to measure the spectral (emission wavelength-dependent) response of the photomultiplier tube. As noted above, a collimator is preferably interposed between the LED array and the input window of the photomultiplier tube so that the light emitted by each LED is incident essentially only on the photocathode of the photomultiplier tube.

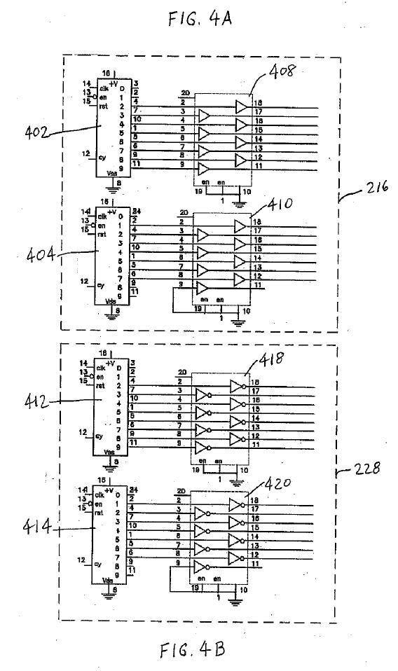

Referring now to FIGS. 4A and 4B, the column counter 216 has positive logic (high voltage) driver outputs that go high to enable a column. The row counter 228 has negative logic (ground voltage) outputs that go low (ground) to enable a row. This creates the pulses 318 and 320 shown in FIG. 3 for the column lines 302, 304, 306, etc., and the row lines 308, 310, 312. . . . The column counter 216 is preferably realized with two type CD4017 (National Semiconductor) integrated circuits 402 and 404 as shown in FIG. 4A. The driver portion of the column counter 216 is preferably embodied with two type SN4HC541 N (Texas Instruments) non-inverting line buffer/driver circuits 408 and 410 having their inputs connected to the outputs of the counter circuits 402 and 404, respectively. As shown in FIG. 4B, the row counters are preferably realized with two type CD4017 integrated circuits 412 and 414 and the outputs of the integrated circuits 412 and 414 are connected to type SN4HC540N inverting line buffer/driver circuits 418 and 420, respectively.

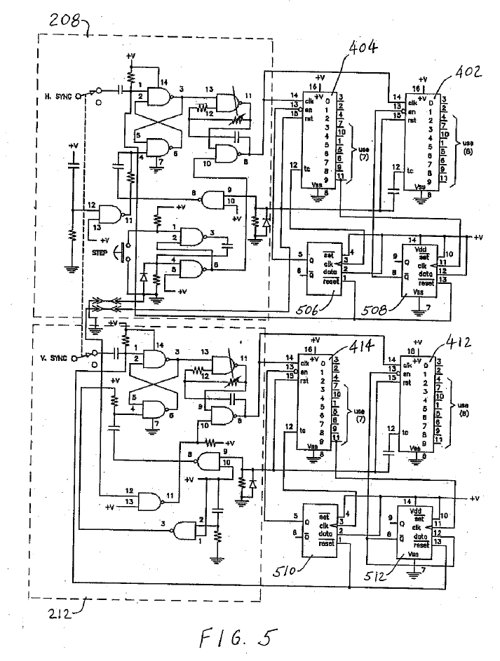

Referring now to FIG. 5, there is shown a preferred circuit arrangement for the row and column timing circuits. This schematic provides more detail of embodiments of the horizontal timing generator 208, the vertical timing generator 212, the horizontal column counter 216, and the vertical row counter 228 shown in FIG. 2 and described generally above. However, it does not include the line drivers 408, 410, 418, and 420 shown in FIGS. 4A and 4B. The horizontal synchronization signal (H. SYNC) and the vertical synchronization signal (V. SYNC) are produced by the video synchronizing pulse generator 202 which is preferably realized with an integrated circuit (e.g., RCA or Harris CD22402, or National Semiconductor LM1882-R) having a preferred crystal frequency of 504 kilohertz. Preferred circuits for the horizontal timing generator 208 and for the vertical timing generator 212 are realized with NAND-gate logic circuits as shown in FIG. 5. The timing circuitry for the horizontal timing stage includes positive-edge-triggered D-type flip-flops 506 and 508 to enable the column counter IC's 404 and 402, respectively. The timing circuitry for the vertical timing stage includes positive-edge-triggered D-type flip-flops 510 and 512 to enable the row counter IC's 414 and 412, respectively.

Referring again to FIG. 2, the photomultiplier tube anode current that is modulated by the scanning probe emission of the LED array is combined as an appropriate weighted sum with the synchronized horizontal and vertical timing and blanking signals 242 and 243 generated by the video synchronization integrated circuit 202 using a video processing amplifier 240″ constructed from operational amplifiers, or using a commercially-available integrated circuit for such purposes.

The video image so produced provides a qualitative indication of photomultiplier tube sensitivity and gain. The overall gain of a photomultiplier tube is the product of photocathode photoemission efficiency and gain associated with each pair of electrodes that comprise the secondary electron cascade. These component gains depend on the voltage biases between the various adjacent electrodes. The electrode biases could be individually varied to observe effects on the video image of responsivity. This should provide some insight on contributions of various components of the photomultiplier to spatial response non-uniformity. For instance, if the video image is very sensitive to the photocathode bias but relatively insensitive to the bias between the anode and its nearest dynode, one might infer that the photocathode performance is the main source of spatial response non-uniformities.

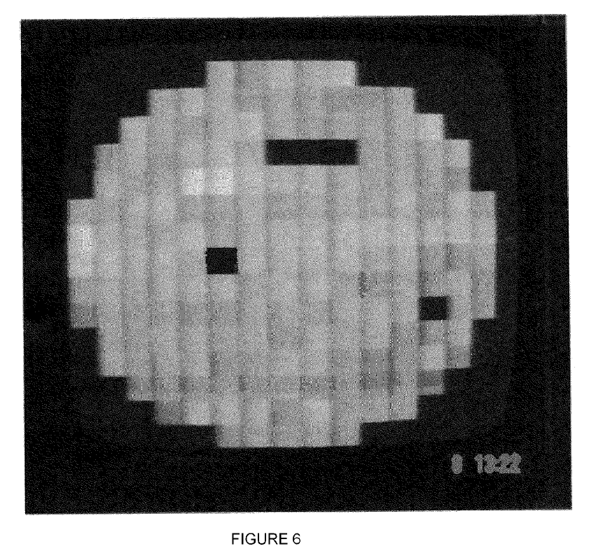

A prototype of the video display imaging apparatus according to the present invention was constructed. The prototype included a 15-row x 15-column LED array as described herein, utilizing green LED's (emission wavelength equal to 550 nm). A 3-inch-diameter round photomultiplier tube was tested. The video display of the photomultiplier tube response was captured using a digital camera. An image of the captured video display is shown in FIG. 6. The bright sections (pixels) of the image correspond to regions of the photomultiplier tube photosensitive area with relatively high responsivity. The image clearly shows the variation in photomultiplier response as a function of location of the incident radiation on the photomultiplier tube that was tested.

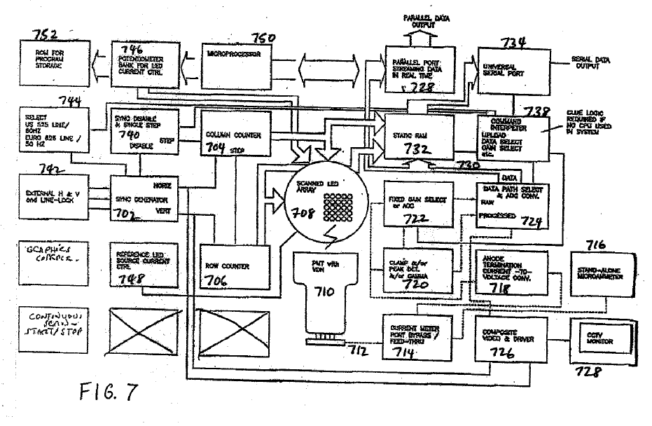

Referring now to FIG. 7 there is shown an alternative arrangement of a system according to the present invention. As in the previously described embodiment, the system of FIG. 7 includes a synchronization generator 702, horizontal oscillator/column counter circuitry 704, vertical oscillator/row counter circuitry 706, and an LED array 708 optically coupled to a photomultiplier tube 710 under test. The anode current 712 from the photomultiplier tube 710 is switched by a selector circuit 714 between a stand-alone microammeter 716 or a current-to-voltage converter 718. The voltage signal from converter 718 serves as input to a clamping/peak-detector circuit 720 and a fixed or automatic gain control (AGC) circuit 722. A data path selector 724 sends the processed anode signal as the analog camera signal component to a video amplifier and driver 726 which forms a composite video signal for input to the television video monitor 728. Data path selector 724 also functions as an analog-to-digital converter. The data bus 730 provides a path to a static RAM buffer 732 for a universal serial data port 734, as well as to a parallel data port 736 for streaming data in real time. These functional blocks are controlled by a command interpreter 738 for selecting the various functions.

The synchronization generator 702 is connected to a synchronization disabler 740 and to an interface circuit 742 which provides horizontal and vertical synchronization signals and line locking from an external source. The configuration shown in FIG. 7 permits several video formats including the 525-line, 60 Hz format used for commercial television in the U.S., and the 635-line, 50 Hz format used in Europe which can be selected with selector circuit 744. This allows the use of the imaging system with television monitors found in different parts of the world. There are many commercial synchronization integrated circuits 740 that may be used for generating signals for either format. The emissive output of each LED is controlled by a potentiometer bank 746 which controls the current input to the LED's. Data for equalizing or compensating LED output is provided by using a reference LED source current controller 748. All of the functions provided for in the system of FIG. 7 are preferably controlled by a microprocessor 750. Data for the command interpreter 738 and the LED current control potentiometer bank 746 can be stored in a ROM 752.

The apparatus and techniques described herein for testing the responsivity of photomultiplier tubes can be readily adapted to other optical detector devices such as image intensifiers, photodetectors, photodiode arrays, and solar cells. Any device that produces a current or voltage in response to radiation incident thereon and that can be probed by a scanning LED array is compatible with the apparatus and amenable to the techniques taught by the present invention. For instance, an LED array can be overlaid atop a solar cell. The photovoltaic current generated by the solar cell in response to incident light is collected by a metalized grid formed in the cell to provide a current analogous to the anode current of a photomultiplier tube. An image created from that current would reveal shunts, defects, and the like in the solar cell.

It will be recognized by those skilled in the art that changes or modifications may be made to the above-described embodiment without departing from the broad inventive concepts of the invention. For example, there is a practically unlimited number of specific realizations of the timing circuitry used to sequence the LED array. Further, many variations in the layout and methods of construction of the LED array are feasible. It is understood, therefore, that the invention is not limited to the particular embodiments which are described, but is intended to cover all modifications and changes within the scope and spirit of the invention as described in the appended claims.

What is claimed is:

1. Apparatus for imaging the response of a radiation responsive device comprising:
an array of discrete radiation emitting devices;
means operatively connected to said array for effecting radiation emission by each of the discrete radiation emitting devices in a scanning sequence;
means for positioning a radiation responsive device to receive radiation from said array; and
display means operatively connected to receive an output signal from the radiation responsive device in response to radiation incident thereon from said array for displaying an image corresponding to the output signal from the radiation responsive device.

2. An apparatus as set forth in claim 1 wherein the discrete radiation emitting devices comprise light emitting diodes.

3. An apparatus as set forth in claim 1 comprising a collimator disposed between the array of radiation emitting devices and the radiation responsive device.

4. An apparatus as set forth in claim 2 wherein the means for effecting radiation emission comprises:
means for generating a synchronization signal; and
means responsive to the synchronization signal for providing a sequenced plurality of pulses to respective row and column inputs of said array for enabling each of said light emitting diodes to emit light radiation in a timed sequence.

5. An apparatus as set forth in claim 4 wherein the means for providing the sequenced plurality of pulses comprises:
a first timing generator operatively connected to said synchronization signal generating means and adapted to provide a first clock signal in response thereto;
a first counter operatively connected to receive the first clock signal and adapted to provide a plurality of column address pulses to the column inputs of said array;
a second timing generator operatively connected to said synchronization signal generating means and adapted to provide a second clock signal in response thereto; and
a second counter operatively connected to receive the second clock signal and adapted to provide a plurality of row address pulses to the row inputs of said array.

6. An apparatus as set forth in claim 5 wherein the first counter comprises a plurality of non-inverting buffer/drivers and the second counter comprises a plurality of inverting buffer/drivers.

7. An apparatus as set forth in claim 1 further comprising means for energizing the radiation responsive device such that the radiation responsive device generates the output signal in response to radiation incident thereon.

8. An apparatus as set forth in claim 1 wherein the display means comprises
a video amplifier connected for receiving the synchronization signal for providing a video signal in response thereto; and
a video display device operatively connected to said video amplifier for receiving the video signal and displaying the image.

9. An apparatus as set forth in claim 1 wherein said array comprises means for adjusting the emission intensity of the discrete radiation emitting devices.

10. An apparatus as set forth in claim 1 wherein the discrete radiation emitting devices are arranged into a plurality of columns and rows.

11. An apparatus as set forth in claim 10 wherein the discrete radiation emitting devices comprise light emitting diodes.

12. An apparatus as set forth in claim 111 wherein the light emitting diodes are adapted for emitting essentially white light.

13. In a method for assessing the responsivity of a radiation responsive device the steps of:
providing an array of discrete radiation emissive devices;
positioning a radiation responsive device that is adapted for generating an output signal in response to radiation incident thereon adjacent to the array of discrete radiation emissive devices so as to receive radiation emitted by each of said discrete radiation emissive devices;
enabling each of the discrete radiation emissive devices to emit radiation in a timed sequence;
enabling the radiation responsive device to generate the output signal in response to radiation incident thereon from the discrete radiation emissive devices; and
generating a video image from the output signal of the radiation responsive device resulting from the sequenced emission of radiation from the discrete radiation emissive devices.

14. The method set forth in claim 13 wherein the step of positioning the array of discrete radiation emissive devices comprises the step of providing light emitting diodes as the discrete radiation emissive devices.

15. The method set forth in claim 14 wherein the step of providing the radiation responsive device comprises providing a photomultiplier tube having a photocathode and the step of positioning the array of light emitting diodes comprises the step of aligning the light emitting diodes to face the photocathode of the photomultiplier tube.

16. The method set forth in claim 15 wherein the step of enabling the radiation responsive device comprises the step of applying a bias voltage to the photocathode.

17. The method set forth in claim 13 wherein the discrete radiation emissive devices are arranged in columns and rows in the array, and the step of enabling each of the discrete radiation emissive devices comprises the steps of:
generating a series of synchronization pulses having a preselected period;
generating pairs of column and row pulses in a timed sequence in response to each of the synchronization pulses; and
applying pairs of the column and row pulses to each of the discrete radiation emissive devices sequentially.

18. The method set forth claim 14 wherein the step of generating the video image comprises the steps of:
combining the output signal with the synchronization pulses to generate a video signal; and
inputting the video signal to a video display device.

19. The method set forth in claim 17 wherein the column and row pulses have respective polarities and the step of generating the pairs of column and row pulses comprises the step of inverting the polarity of the row pulses before they are applied to the discrete radiation emissive devices.

20. The method set forth in claim 19 wherein the step of positioning the array of discrete radiation emissive devices comprises the step of providing light emitting diodes as the discrete radiation emissive devices.

21. The method set forth in claim 20 wherein the step of providing the radiation responsive device comprises providing a photomultiplier tube having a photocathode and the step of positioning the array of light emitting diodes comprises the step of aligning the light emitting diodes to face the photocathode of the photomultiplier tube.

22. The method set forth in claim 13 comprising the step of collimating radiation emitted by each of the discrete radiation emissive devices so that substantially all of the radiation is incident on the radiation responsive device.
